(19) United States
(12) Patent Application Publication
(10) Pub. No.: US 2024/0156274 A1
(43) Pub. Date: May 16, 2024

(54) System for Raising and Lowering Furniture

(71) Applicant: Hall Labs, LLC, Provo, UT (US)

(72) Inventors: David R. Hall, Provo, UT (US); Jonathon Marshall, Mapleton, UT (US); Benjamin Jensen, Orem, UT (US)

(21) Appl. No.: 18/509,279

(22) Filed: Nov. 14, 2023

Related U.S. Application Data
(60) Provisional application No. 63/383,623, filed on Nov. 14, 2022.

(51) Int. Cl. A47C 17/84; A47C 17/04; B66D 1/60

(52) U.S. Cl. CPC A47C 17/84; A47C 17/04; B66D 1/60

(57) ABSTRACT

A system for raising and lowering furniture, comprising: a dwelling unit comprising a dwelling residential zone for occupants and a storage zone for furnishings above the residential dwelling zone; at least one lifting device attached to an item of furniture; at least one runner attached to the item of furniture; and at least one vertical channel adapted to engage with the at least one runner as the item of furniture is raised or lowered to or from a storage zone above the room; whereby the furniture is supported by the connection to the lifting device; whereby the at least one runner travels along the at least one channel as the item of furniture is raised or lowered is disclosed. A system for adjusting the height of fixtures in a dwelling unit, comprising at least one lifter with a base below the floor line of the dwelling and extending through the floor of the dwelling wherein the lifter is adapted to lower the fixture down to or near floor level is also disclosed. A system for rearranging the furniture in a room, comprising: at least one lifter with a base below the floor line of the room and extending through the floor of the room wherein the lifter is adapted to lower the fixture down to or near floor level; at least one lifting device attached to an item of furniture; at least one runner attached to the item of furniture; and at least one vertical channel adapted to interact with the at least one runner as the item of furniture is raised or lowered to or from a space above the room; whereby the furnishing is supported by the connection to the lifting device; and whereby the at least one runner travels along the at least one channel as the item of furniture is raised or lowered is also disclosed.

### CROSS-REFERENCE TO RELATED APPLICATIONS

This application claims the benefit under 35 U.S.C. § 119(e) of U.S. Provisional Patent Application No. 63/383,623 titled “System for Raising and Lowering Furniture and Furnishings” filed on 14 Nov. 2022, which disclosure is incorporated herein by reference in its entirety.

### TECHNICAL FIELD

The present disclosure relates to dwelling units. More particularly, it relates to a compact, modular dwelling unit with spaces convertible between configurations for different uses. In addition, it relates to modular dwelling units that are adapted to be combined horizontally and vertically into multiple-unit buildings.

### BACKGROUND

Open space available for development of new housing is increasingly difficult to find in American cities and in many other cities around the world. In many crowded cities, existing available living space can be very small due to the need to fit more people in the same space. For that reason, it would be of great benefit to design living spaces that provide more functionality in limited living space. For example, much of the space in a conventional home is taken up by bedrooms that are vacant about two thirds of the time. It would be beneficial to be able to adapt these spaces to be more usable during non-sleeping time. The present disclosure addresses designs for dwellings with smaller footprints that have the amenities of larger homes and methods of constructing the same.

### SUMMARY

In a first aspect, the disclosure provides a system for raising and lowering furniture, comprising: a dwelling unit comprising a dwelling residential zone for occupants and a storage zone for furnishings above the residential dwelling zone; at least one lifting device attached to an item of furniture; at least one runner attached to the item of furniture; and at least one vertical channel adapted to engage with the at least one runner as the item of furniture is raised or lowered to or from a storage zone above the room; whereby the furniture is supported by the connection to the lifting device; whereby the at least one runner travels along the at least one channel as the item of furniture is raised or lowered.

In a second aspect, the disclosure provides a system for adjusting the height of fixtures in a dwelling unit, comprising at least one lifter with a base below the floor line of the dwelling and extending through the floor of the dwelling wherein the lifter is adapted to lower the fixture down to or near floor level.

In a third aspect, the disclosure provides a system for rearranging the furniture in a room, comprising: at least one lifter with a base below the floor line of the room and extending through the floor of the room wherein the lifter is adapted to lower the fixture down to or near floor level; at least one lifting device attached to an item of furniture; at least one runner attached to the item of furniture; and at least one vertical channel adapted to interact with the at least one runner as the item of furniture is raised or lowered to or from a space above the room; whereby the furnishing is supported by the connection to the lifting device; and whereby the at least one runner travels along the at least one channel as the item of furniture is raised or lowered.

Further aspects and embodiments are provided in the foregoing drawings, detailed description, and claims.

### BRIEF DESCRIPTION OF THE DRAWINGS

The following drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1 is a perspective view of a first exemplary embodiment of a dwelling according to the present disclosure.

FIG. 2 is a perspective view of the embodiment of FIG. 1.

FIG. 3 is a perspective view of three of the embodiments of FIG. 1 combined into a single building.

FIG. 4 is a perspective view of 14 of the embodiments of FIG. 1 combined into a single one-story building.

FIG. 5 is a perspective view of the 28 of the embodiments of FIG. 1 combined into a single two-story building.

FIG. 6 is a perspective view of the 42 of the embodiments of FIG. 1 combined into a single three-story building.

FIG. 6A is a perspective view of several of the three-story buildings of FIG. 6 combined into a larger building.

FIG. 7 is an end plan view showing exemplary examples of four vertical zones in an ADU according to the present disclosure.

FIG. 8 is a top plan view of an exemplary embodiment of the lifters in the mechanical zone of the embodiment of FIG. 7.

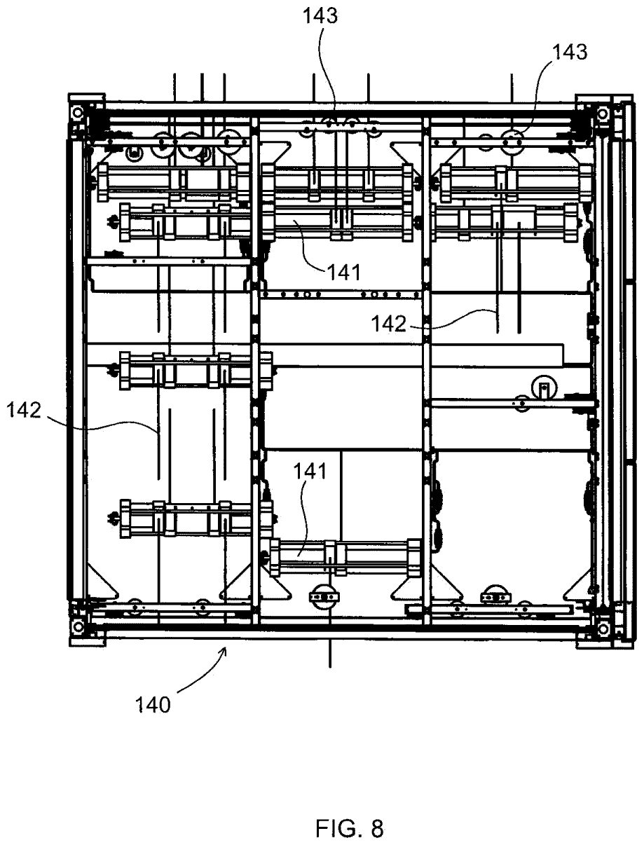

FIG. 9 is a perspective view of a modular room with a bed lowered using an exemplary embodiment of a lifting system according to the present disclosure.

FIG. 10 is a perspective view of a portion of the embodiment of FIG. 9.

FIG. 11 is a perspective view of an exemplary embodiment of a female receiver for an exemplary embodiment of a lifter connection according to the present disclosure.

FIG. 12 is a perspective view of exemplary embodiments of a male connector and actuating motor of the lifter connection of FIG. 9.

FIG. 13 is a perspective view of a first exemplary embodiment of a kitchen and utility insert showing the kitchen side according to the present disclosure.

FIG. 14 is a perspective view of a third exemplary embodiment of a kitchen and utility insert showing the utility side according to the present disclosure.

FIG. 15 is a cross-sectional side plan view of an exemplary embodiment of a system for attaching a wire to a cabinet or other fixture to be lowered into the residential zone according to the present disclosure.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

### Definitions

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

As used herein, “fixture” is meant to refer to home furnishings and utilities that are not adapted to be put into the storage zone. This includes furnishings that are lowered down to floor level or near to floor level to make room for other furniture. Examples of typical fixtures include, but not limited to, sinks, oven/stove, refrigerator/freezer, bath/shower, toilet, and kitchen island. In some embodiments, these examples may be storable and not fixtures.

As used herein, “furniture” is meant to refer to home furnishings that are intended to be placed into the storage. Examples of furniture include, but are not limited to, tables, seats, couches, beds, dressers, closets, pantries, and exercise equipment. In some embodiments, the examples may not be designed for storage and are installed as fixture.

As used herein, “panel” is meant to refer to a cuboid of homogenous or non-homogenous material used as at least a partial divider of a space.

As used herein, “track” is meant to refer to a strip of material formed so as to allow movement along a given path in a consistent manner.

As used herein, “track follower” is meant to refer to a small piece of material that is attached to a panel or piece of furniture and rides in the track. A track follower keeps the panel material or furniture in line with the track and forces the panel or furniture to follow the path set by the track as the track follower moves along the track.

As used herein, “divider” is meant to refer to one or more panels used to the divide the space.

As used herein, “overhead position” is meant to refer to any space above the space to be divided. Preferably, this space will be above the ceiling, but is not restricted to this.

As used herein, “spool” is meant to refer to a generally cylindrical member that rotates to wind a line thereon.

As used herein, “line” is meant to refer to any device or material that is long, cylindrical, thin, flexible, and having a high tensile strength and is also preferably capable of being spooled. Preferably, this will be a braided wire, but ropes, cords, string, twine, cable, strand, chains and combinations thereof may be used as well.

As used herein, “sound dampeners” is meant to refer to a passive material or an active device used to diminish the sound transfer through the divider.

As used herein, “gasket” is meant to refer to any material used to make a seal between two abutting surfaces. Gaskets may also be sound dampeners.

As used herein, “locking mechanism” is meant to refer to any mechanism designed to reversibly hold a plurality of objects together to prevent the dislocation of their current positions.

As used herein, “winch,” “hoist,” “lift,” “winching device,” “hoisting device,” and “lifting device” are meant to refer to an apparatus that can be actuated to selectively raise and lower an object. These terms are generally interchangeable except for where specifically noted herein.

### Exemplary Embodiments

The present disclosure relates to compact modular dwelling units for individuals and families. In various exemplary embodiments, the disclosed modular dwelling units are designed with spaces that can be converted between configurations for different functions or uses. For example, sleeping space may be converted into living room, office, exercise, dining, or entertainment space as needed by replacing the bed with other furniture. To accomplish this, the modular dwelling units include storage space into which furniture may be readily transferred when not in use.

In various exemplary embodiments, a modular dwelling unit comprises four vertical zones: mechanical, storage, residential, and utility, from top to bottom. Each zone has a different purpose as described in greater detail below.

In various exemplary embodiments, a modular dwelling unit is manufactured in a controlled environment and shipped to the building location for installation. In one embodiment, the unit is shipped in two parts (two upper zones and two lower two zones) for safety and to facilitate shipping on roadways with limited vertical clearance (a preferred embodiment is about 14 feet in height).

In various exemplary embodiments, the dwelling units are designed so that two or single units may be combined into a single-family dwelling (referenced herein as a double unit, triple unit, etc.). In various exemplary embodiments, the dwelling units are designed so that two or more units may be combined into a single building with multiple family dwellings (containing single, double, or larger units). They may be combined horizontally and vertically. In a preferred embodiment, a multi-unit building may also be built providing common access points, common hallways, and communal spaces.

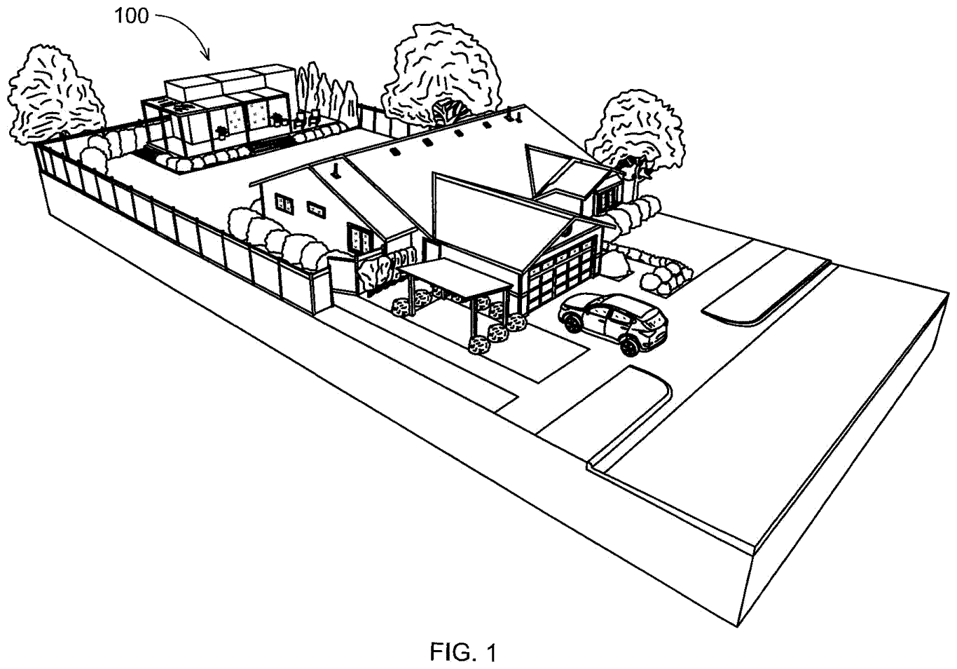

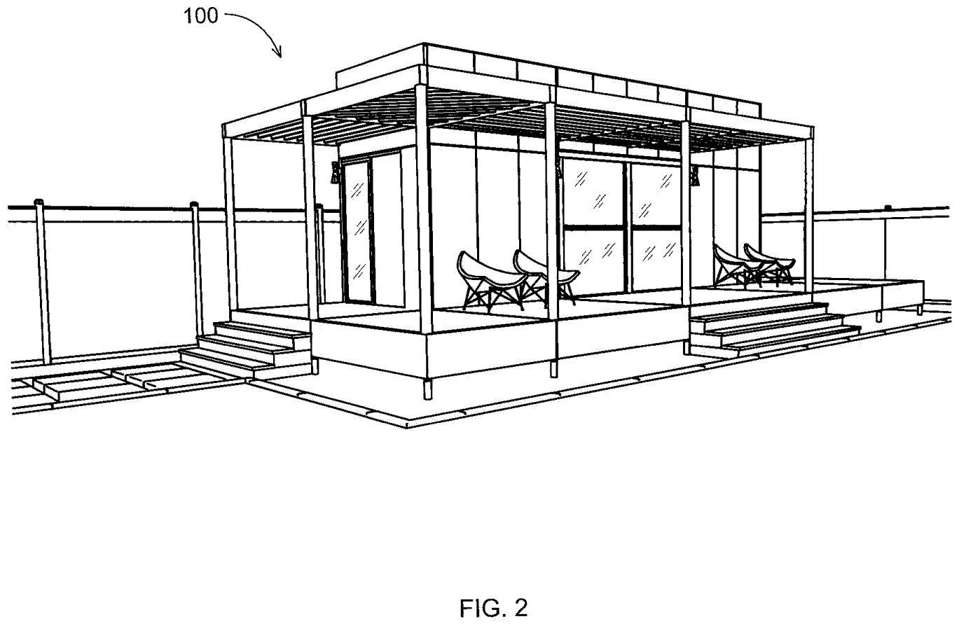

Referring to FIGS. 1 and 2, an exemplary embodiment of a single dwelling unit 100 according to the present disclosure is shown installed on the lot of a traditional single family zoned property with a house. In various exemplary embodiments, the unit 100 is designed as a standalone unit with all the needed features for its occupants. In a setting such as shown, the unit would most likely be connected to the primary residence's utility services but those could be provided separately.

As shown in FIG. 2, a single unit 100 may be provided with ample open, covered, or partially covered outdoor space for porch furniture and the like. In various exemplary embodiments, external spaces such as porches have the same dimensions as the modules and are installed on pilings in the same manner as the dwelling.

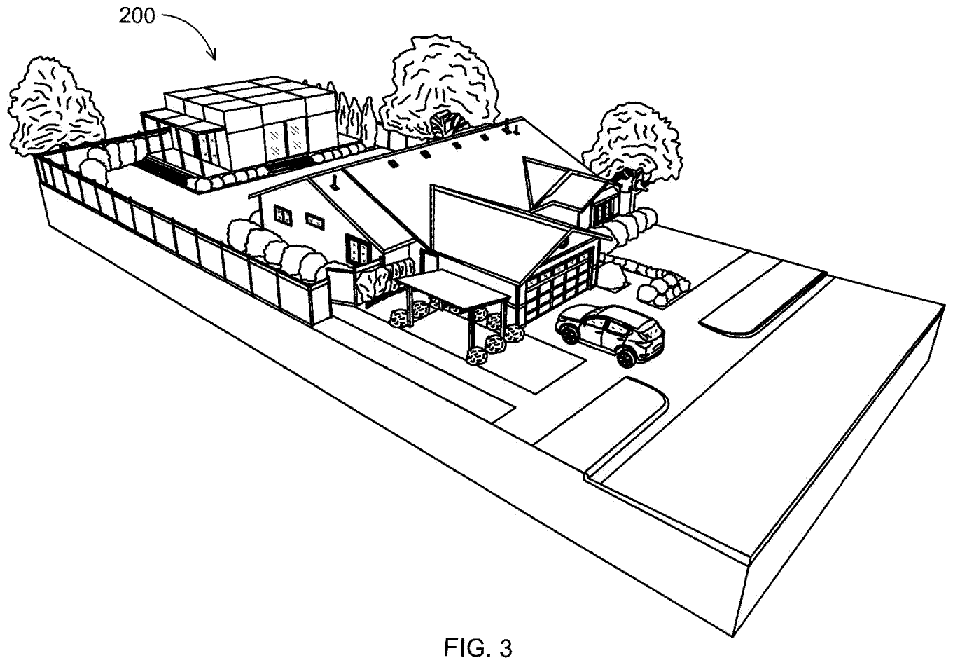

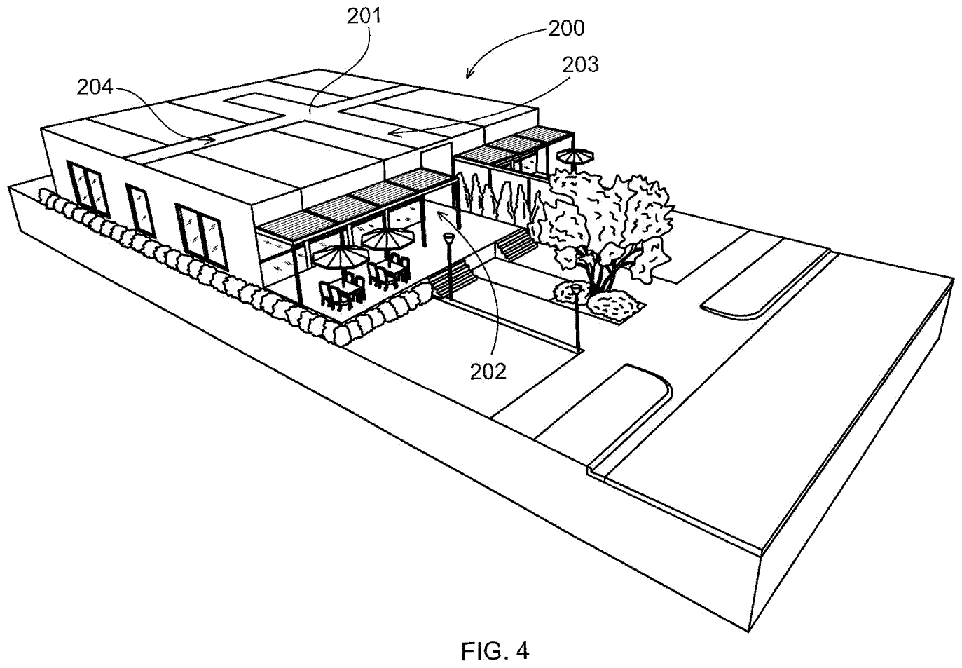

Referring now to FIG. 3, three of the units of FIGS. 1 and 2 are combined to form a single multi-family dwelling building 200. The building 200 may be configured with three single units, a single and a double unit, or a triple unit. In this configuration, each of the units has an entrance/exit onto a common external porch area. Additional outdoor space, such as shown in FIG. 2 may also be provided. The single unit includes a floored exterior on at least the end with the entrance which may become an internal hallway in larger combinations of units, such as shown below in FIGS. 4-6A.

Now referring to FIGS. 4-6A, multiple units are combined to form a single-story, multi-unit building. In the embodiment of FIG. 4, the building 200 comprises a single-story with fourteen units (rotated 90° from the orientation shown in FIGS. 1-3), which may be arranged as single or double units. Internal common hallways 203 and 204 (shown with sky lights 201) provide access to individual units. In the illustrated embodiment, a single entrance 202 at the front of the building 200 leads to a first hallway 203 down the length of the building that is crossed by a second hallway 204 that extends the width of the building. In this configuration, the second hallway 204 provides access to individual units in similar fashion to the common porch of FIG. 2.

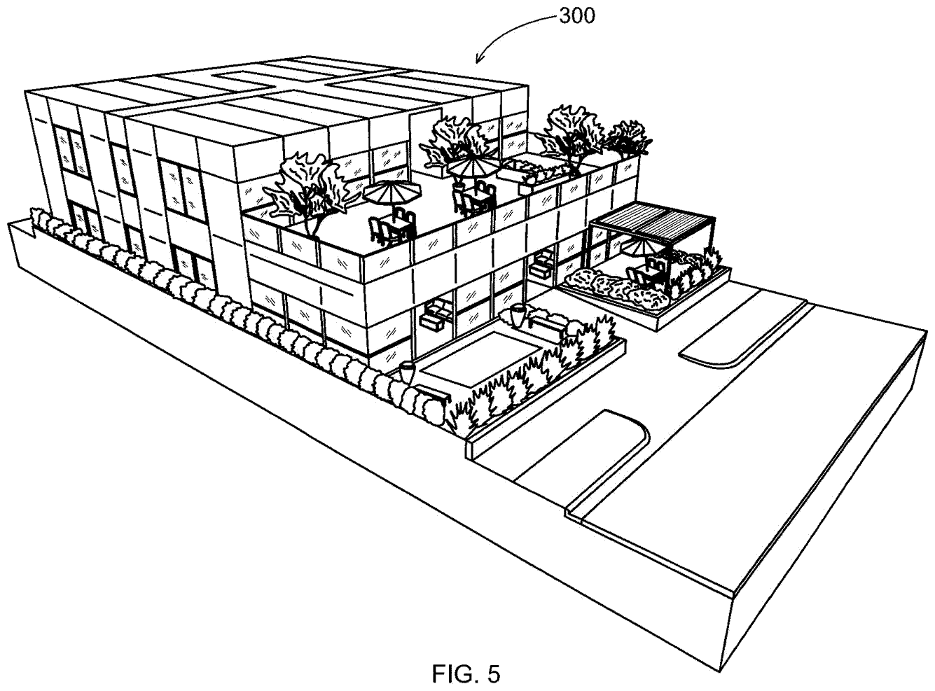

Referring more specifically to FIG. 5, the fourteen units are doubled to twenty-eight by placing a second story of fourteen more units directly above the units in FIG. 4. In addition, the front of the building 300 has been expanded to provide common space on each floor for the building occupants. In various exemplary embodiments, an elevator and/or stairs (preferably with a lift for handicapped residents) may be added to the end of the first hallway space to provide access to the upper floor(s).

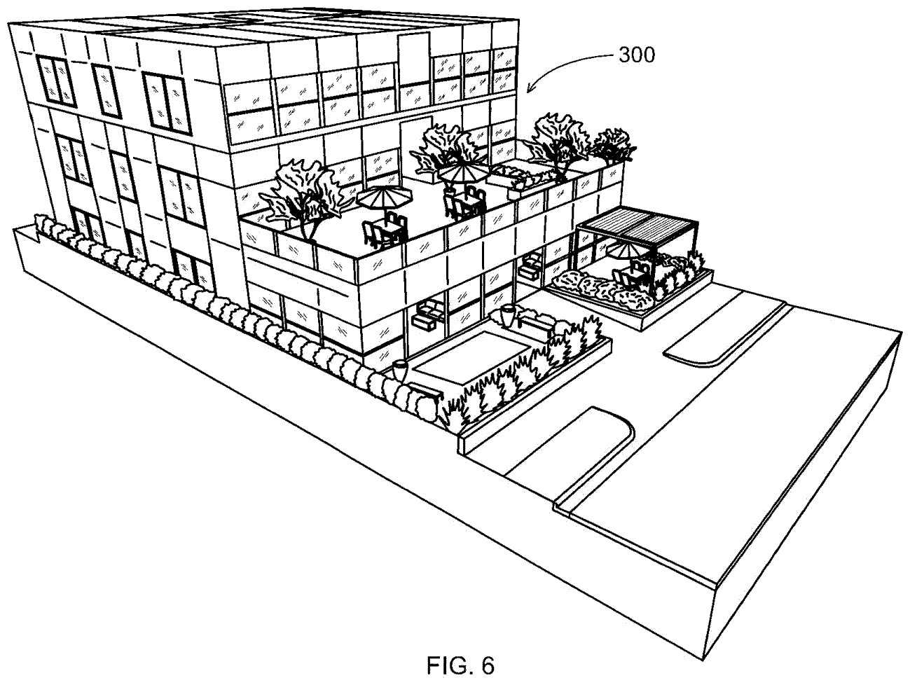

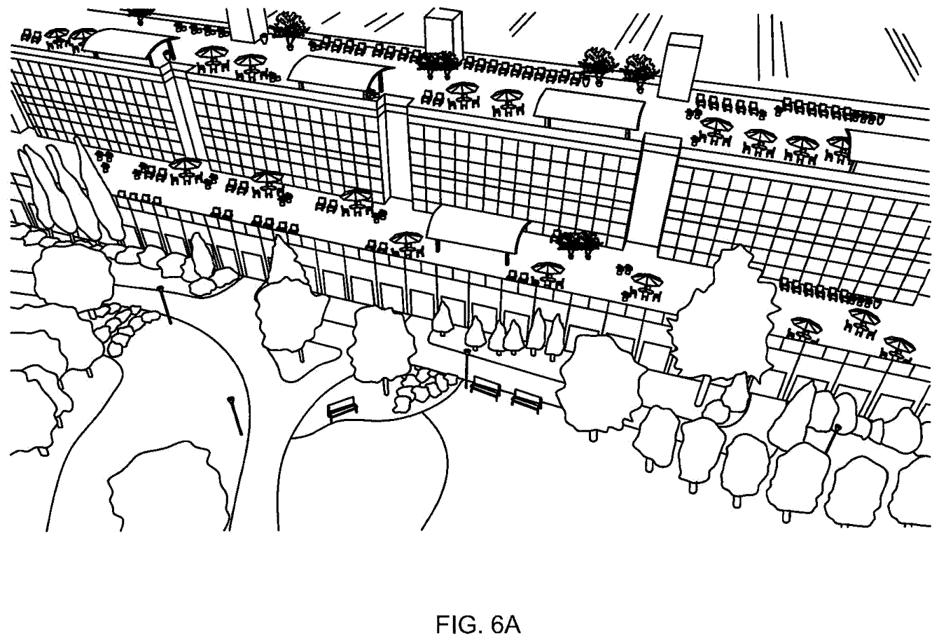

Now referring to FIG. 6, a third story has been added to the building 300 to bring its size to forty-two units. Now referring to FIG. 6A, units like that in FIG. 6 are adjoined into a significantly larger buildings for a larger community.

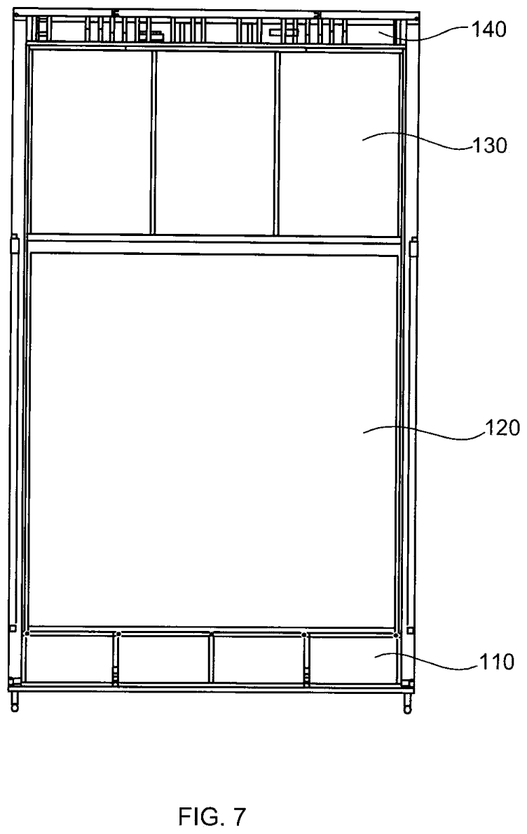

Now referring to FIG. 7, an exemplary embodiment of the dwelling unit is illustrated. In a preferred embodiment, the vertical dimensions for the zones are utility about 16 inches, dwelling about 95 inches, storage about 48 inches, and mechanical about 9 inches.

In various exemplary embodiments, the modular dwelling unit is divided vertically into four zones: utility 110 (base), residential or occupant 120, storage 130, and mechanical 140, from bottom to top. The utility zone 110 contains substantially all the electrical, plumbing, and HVAC ductwork connections for the dwelling unit. The residential zone 120 is designed for human occupancy. The storage zone 130 is adapted to store various furniture pieces (including storage compartments for clothing, food, etc.) when such is not needed in the residential zone. The mechanical zone 140 contains the lifting devices and associated cables and other hardware used to raise and lower the various furniture pieces into and out of the storage zone. In some embodiments, the mechanical zone includes electrical connections to power the lifting devices, ceiling lights, and to provide power to some furniture (e.g., video screens) when lowered for use.

In preferred embodiments, the furnishings, dividers, and anything else that is intended to be raised or lowered is connected or connectable to a hoisting device comprising a motor, spool, and line. In some embodiments, multiple hoisting devices are used to raise and lower the same object. Useful hoisting devices are disclosed in 63/372,327 titled “Winch with Supporting Rod” filed 23 Aug. 2022; Ser. No. 18/060,532 titled “Winch with Multiple Spools on Single Driveshaft” filed 30 Nov. 2022; Ser. No. 18/060,534 titled “Winch with Helical Groove and Line Guide” filed 30 Nov. 2022; Ser. No. 18/060,536 titled “Winch with Spool and Remote Tensioning Wheel” filed 20 Nov. 2022; Ser. No. 18/060,539 titled “Hoisting Device with Multiple Line Types on Driveshaft” filed 30 Nov. 2022; and Ser. No. 18/060,553 titled “Winch with Line Guide Driven by Wound Line” filed 30 Nov. 2022; each of which are incorporated herein by reference in their entireties.

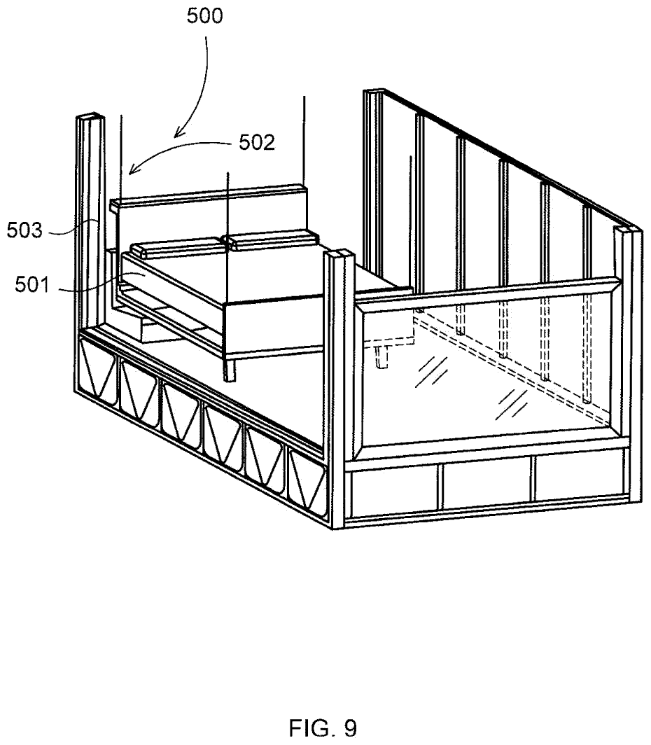

Now referring to FIG. 9, an exemplary embodiment of a mechanical zone 140 is shown. In a preferred embodiment, hoisting devices 141 are attached to the furniture via lines 142 that may pass through one or more pulleys 143. The hoists 141 and pulleys 143 may be placed at different heights to facilitate spacing for more hoisting devices.

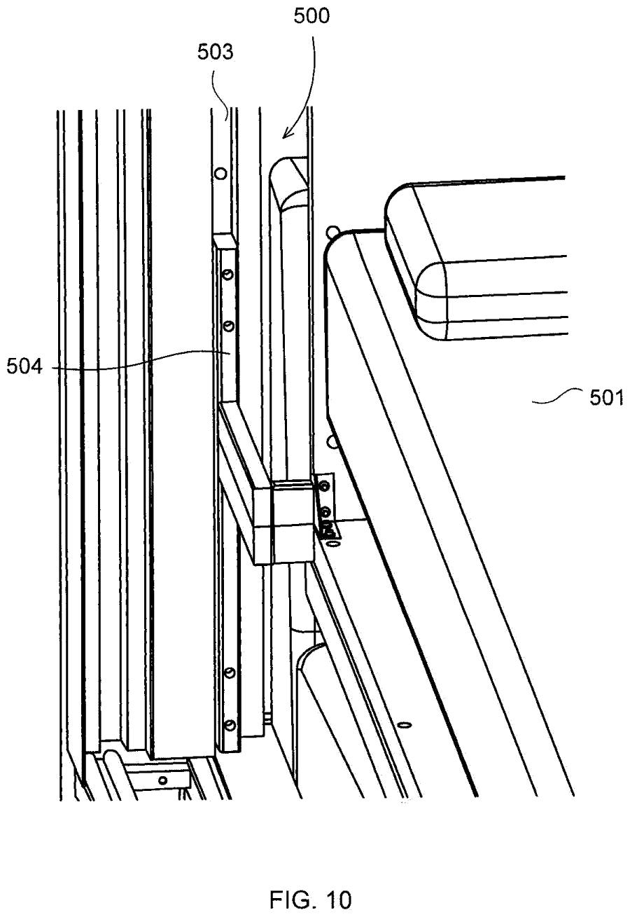

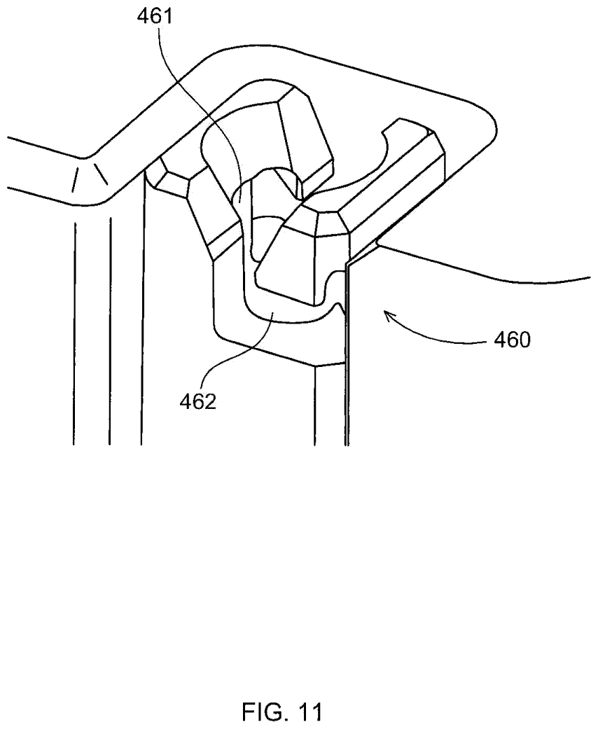

Now referring to FIG. 10, a piece of furniture 501 (in this example, a bed) is shown being lowered using an exemplary embodiment of a lifting/lowering system 500. The furniture piece 501 is connected to a cable 502 which bears the weight of the furniture piece 501. As shown in more detail in FIG. 11, the system 500 also includes at least one channel or guide 503 and a runner 504 that is adapted to fit into the channel 503. The runner 504 is connected to the furniture piece 501 and is inserted in the channel 503, which guides the furniture piece 501 as it is moved keeping it in place. In various exemplary embodiments, the guides 503 are generally C-shaped. In a preferred embodiment, two guides 503 are disposed opposite one another with the open sides facing each other. In this embodiment, the channels 503 and runners 504 confine the furniture piece 501 such that it can move up and down but is constrained from moving laterally in any direction. In various exemplary embodiments, the runner 504 comprises a roller or wheel that turns as the furniture piece is raised or lowered. In a less preferred embodiment, the runner 504 comprises a slider that glides up and down the guide 503. The cable 502 is preferable connected to the runner 504 and is enclosed in the channel 503. In some embodiments, two or more runners 504 are provided for each channel 503.

In various exemplary embodiments, a modular dwelling unit is constructed from a plurality of modular rooms that are combined to form the dwelling. In other embodiments, the unit is constructed with a single frame subdivided into rooms.

The residential zone preferably includes at least one module/room adaptable as two or more of a bedroom, living room, dining room, entertainment room, and office, among other possibilities. In various exemplary embodiments, dividing walls may be lowered into place separating one modular room from another.

The flex space includes the kitchen area and may include an oven/stove, dining space, pantry, cabinets, refrigerator/freezer, and/or a kitchen island and/or desk with built-in seating. In some embodiments, the flex room may also be converted to a sleeping area. In a preferred embodiment, the flex room includes a large sliding wall, preferably glass, that may be used as an exit in a single module unit or as a connection between two adjacent modules combined into a single dwelling.

The bathroom module includes the bathroom, laundry appliances, and storage above (this may be closets, drawers, or shelves for towels or laundry detergent, etc.). In a preferred embodiment, the utility zone also includes a doorway for entry and exit from the module. As discussed above, when the modules are combined into a multi-unit building, these doors become the primary and often only entrance or exit for the module. The space above the entryway in the utility module preferably includes closets or other storage compartments.

In various preferred embodiments, furnishings that require plumbing connections (e.g., sinks, toilet, shower, washers) are permanent fixtures meaning that they are not raised or lowered into the storage zone. However, they may be designed to be raised or lowered in place based on the needs of the occupants (e.g., for persons in a wheelchair). Some fixtures (e.g., tables, seats) may be lowerable to the floor to make space available for furniture to be lowered down into the residential zone.

In various other embodiments, the unit may have more or fewer modules/rooms. In a preferred embodiment, the room modules are 8′3″ wide by 16′ long. In various exemplary embodiments, the porch is now enclosed and configured with a bed for sleeping. The vista and living rooms may be similarly reconfigured.

In various exemplary embodiments, different combinations of the modules may be combined into other combinations, which may include any number of sections including duplicate sections in the same unit. In preferred embodiments, the kitchen with dining and sleeping capability and the bathroom with utility are considered the minimum necessary for a dwelling. In various exemplary embodiments, the unit includes an “open” space outside the entrance to the unit that is half the width of a module. For a single or small number of units together, this may provide a patio space. When the units are combined into a building with multiple units, this space becomes a hallway providing access to units. The units are preferably arranged so that the hallway is the width of a single module by connecting units such that two hallways are combined with entrances across the hallway. In various exemplary embodiments, a utility box with circuit breakers, water main valve, etc. is located in or accessible from the utility module's entryway or on the end of the unit outside the utility module door into the unit.

In various exemplary embodiments, multi-dwelling buildings include common spaces such as hallways, kitchens, dining rooms, entertainment space, etc. In some embodiments, these common spaces comprise modular rooms identical in dimensions to the modular rooms that comprise the dwellings. Preferably, the building is built on a grid of modules to provide structural support for multiple floors.

In various exemplary embodiments, multiple floors are assembled by locking the bottom of one unit to the top of another unit. In a preferred embodiment, each module is adapted to include a locking mechanism at each corner in the same pattern as the pilings. In various exemplary embodiments, the system for connecting one floor to another above or below is similar to the system for placing the first floor on the pilings. In various exemplary embodiments, the locking mechanism also is used to connect individual units to adjacent units on the same floor as well. Because the modules are preferably assembled off-site, it is important that the locking mechanism be designed for easy connection when lowering one module on top of another.

In various exemplary embodiments, the roof is designed to collect and drain water, whether from natural sources or a leak from a unit above. The modules have roof sections that function much like a tub to collect water, direct it to a drain, and dispose of the water. Water may be discharged outside the building, into sewage drains, or stored (possibly purified) for later use (e.g., irrigation, etc.).

In various exemplary embodiments, the ADU is designed such that single units can be combined into large, multi-family dwellings. Because the exterior walls of many such units will be on the interior of a larger building, they are inaccessible from outside the unit. Similarly, the utility, storage, and mechanical zones are inaccessible from outside the unit. Therefore, these spaces are installed and accessible for maintenance or repair from the interior of the ADU. For this reason, the ADU is designed with a plurality of removable wall and floor panels allowing access to the utility zone and to the inside of walls. In various exemplary embodiments, outside walls may be covered with a variety of facades such as are used in conventional buildings.

In various exemplary embodiments, the preferred rigid panels for floor or wall panels comprise, for example, a stiff layer of G10 fiberglass (0.030-0.090″), Formica, FRP, or plastic, etc. glued to the Extruded Polystyrene (XPS) Rigid Foam (e.g., Owens Corning FOAMULAR 150 1″×4′×8″ R-5) and on the opposing side another stiff layer of material like G10 fiberglass (0.030-0.090″), Formica, FRP (fiber reinforced plastic), or plastic, etc. glued to the foam on that side. The stiff layer of material can be glued onto the foam with various gluing methods (i.e., hot melt plastic glues, epoxies, contact cement, construction glues, etc.). Once the stiff layers are glued onto the XPS foam the member becomes a composite member having significant more strength than the foam by itself or the stiff members by themselves. This composite material offers many advantages since it has insulating properties it can be used in flooring and, in some configurations, it is strong enough to be used as the sub-floor that can be walked on and furniture placed on. It can also be used in walls and ceilings as well as an insulative outer layer to protect the building.

Other material can be used instead of foam materials for the interior of the composite panels. In various exemplary embodiments, the insulation for the interior of floor and wall panels comprises foams such as discussed above or vacuum insulated panels (VIP). VIP panels allow for much better insulation than the foam materials that are available.

Examples of composites appropriate for floor and/or wall panels include, but are not limited to, Formica or Formica like materials on both sides of an XPS foam; G10 or fiberglass like materials on both sides of an XPS foam; Graphite fiber sheets, Kevlar, or other fiber composite type sheets glued to both sides of the XPS foam; fiber reinforced plastic (FRP) or similar type materials glued to both sides of the SPX foam; and plastic layers like polyethylene, acetal, nylon, PVC, polycarbonate, acrylic, polypropylene, PTFE, etc. again glued to the XPS foam; or canvas phenolic attached to the sides of the insulation. Fiber reinforced plastics, rubbers, or fiber reinforced rubbers can also be used.

In various exemplary embodiments, it may be desirable to separate part of a dwelling from another, for purposes such as providing privacy or noise reduction. In embodiments where two units are combined to form a larger unit, doorways between the units are needed. It may also be desirable to remove or add walls between the units, such as to create open space or provide private space (e.g., for sleeping, etc.) as needed. Exemplary apparatus and systems for this purpose are disclosed in U.S. patent application Ser. No. 16/447,956 titled “Systems for Reversibly Dividing a Space” filed on 20 Jun. 2019 now U.S. Pat. No. 11,359,372 and U.S. patent application Ser. No. 17/806,779 “System for Reversibly Dividing a Space” filed on 14 Jun. 2022, the disclosures of which are included herein in their entireties by reference.

Cables provide an efficient and effective medium for raising and lowering features but having cables extending from the top of a component such as a couch or table up to the ceiling is unsightly, an obstacle, and poses potential danger. For those reasons, various exemplary embodiments include a system for raising and lowering components that does not require a permanent connection to the component. Rather the lifting device may be detached from the component and raised back into the storage space above the ceiling.

Referring now to FIG. 11, an exemplary embodiment of a female receiver 460 adapted for use in a component is shown. The receiver includes a central opening 461 into which a connector may be lowered. It further includes one or two channels 462 for receiving locking pins.

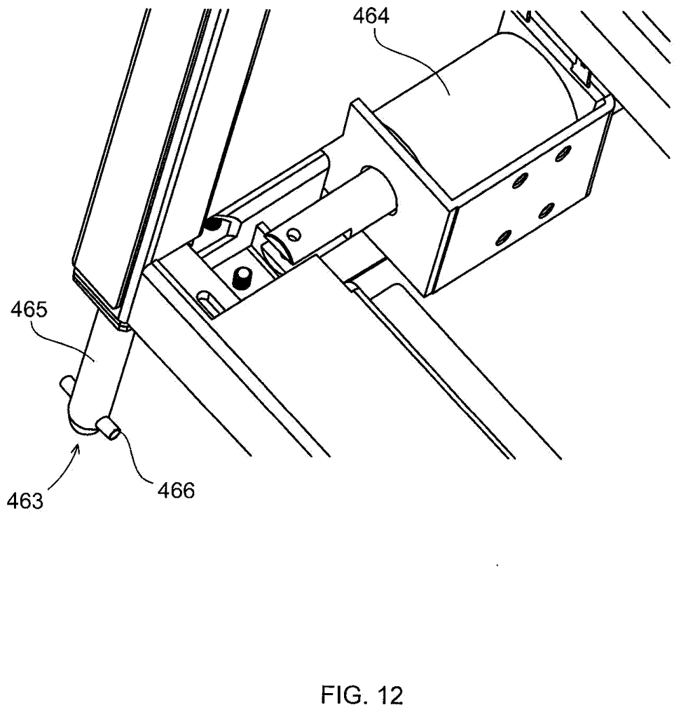

Now referring to FIG. 12, an exemplary embodiment of a connector 463 and motor 464 are shown. In one preferred embodiment, the connector includes a rod 465 with two locking pins 466 extending from opposite sides. The rod 465 is adapted for insertion into the receiver 460 with the pins 466 entering the channels 462. When the rod 465 is inserted, the rod 465 may be rotated such that the locking pins 466 engage with the channels 462 such that when the rod is lifted, the locking pins engage with the top of the channel and lift the receiver and connected component with it. When the component is lowered to the floor, the rod is rotated to disengage the pins with the channel allowing the rod to be raised back into the storage zone. In various exemplary embodiments, the rod is part of a component or other mechanism that is raised and lowered with cables as described above.

In various exemplary embodiments, some kitchen and bathroom/utility room features are built separately and placed in the building frame after assembly. An exemplary embodiment of such a construct includes an over/stove top, kitchen sink, and refrigerator/freezer on one side and a bathroom sink and space for stacked washer/dryer on the other side. In some embodiments, the kitchen fixtures are height adjustable to accommodate occupants of varying heights and the handicapped.

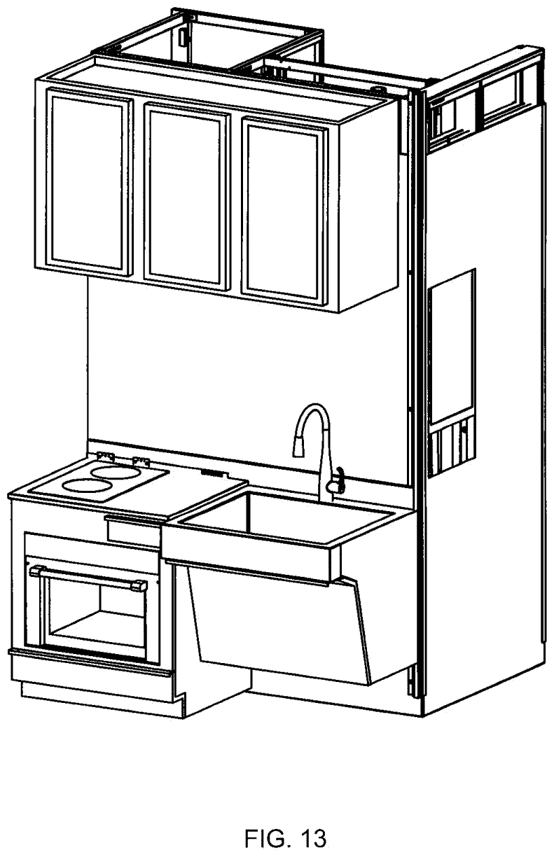

Now referring to FIG. 13, an embodiment of a construct with kitchen fixtures. The module includes a sink, oven, stove, and a small counter space. The kitchen module may include an island/table with more storage and counter space. The construction also includes refrigerator/freezer space above the sink and oven. In various exemplary embodiments, pantry space is provided by storage units kept in the storage zone above the kitchen when not being accessed by the occupants.

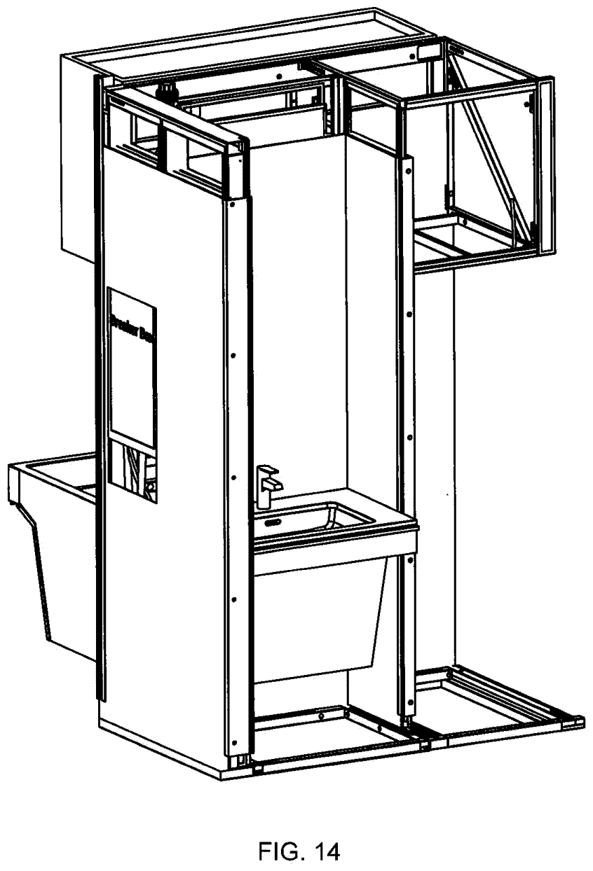

Now referring to FIG. 14, the opposite side of the assembly is shown. The bathroom side of the assembly includes a sink and space for a stacking washer and dryer. The panel above the sink is preferably hinged to allow access to and/or viewing of wiring, plumbing, etc. in the interior of the assembly.

In various exemplary embodiments, a variety of furniture (e.g., beds, chairs, tables, counter, couches, exercise equipment, etc.) is available for use only as needed. In various exemplary embodiments, furniture is stored above the residential zone in the storage zone. In various exemplary embodiments, some fixtures are lowered down to the floor to make room for furniture to be lowered. For example, a tabletop may drop down to floor level using a mechanism built into the utility zone below the floor. In preferred embodiments, the actuators for lowering and raising fixtures to and from floor level are in their legs. In preferred embodiments, the actuators are column lifters. The number of column lifters used for a particular fixture will vary based on the size and weight of the fixture.

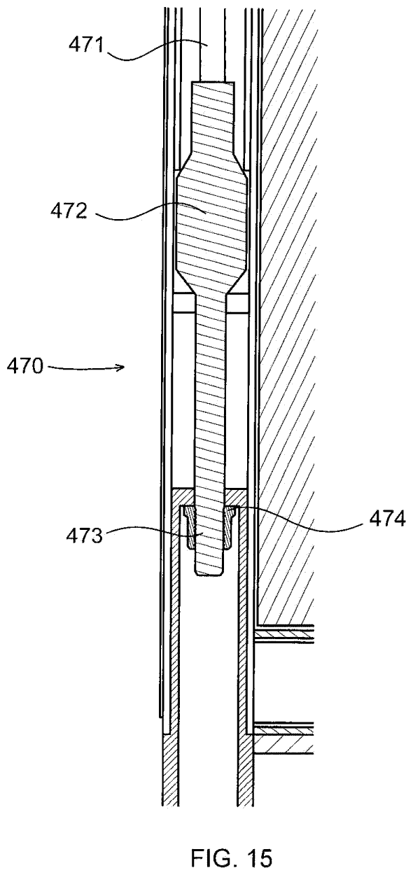

Now referring to FIG. 15, an exemplary embodiment of an attachment mechanism 470 is shown. In this example, a cabinet, closet, or other storage compartment is attached at or near the bottom to a wire 471 that is used to raise and lower the cabinet. Furthermore, the connection 470 is accessible via the bottom of the cabinet to allow access to the connection after installation. This allows the cabinet to be disconnected from the wires and removed for cabinet and lifting device repair or replacement. In a preferred embodiment, at least two wires on two corners are attached to the cabinet. In various preferred embodiments, the wire is attached to a pin 472 that is dropped down a channel along a corner of the cabinet. The pin 472 includes a threaded bolt section 472 at its bottom. The pin passes through a narrow point and a nut 474 is attached to the bolt securing the pin 472 in place. The nut 474 may also be used to adjust the position of the pin 472 relative to the bottom of the cabinet to level the cabinet.

In an exemplary embodiment, the table and seating portion of the bench drop down to the floor to make room for a bed that is lowered into place. In some embodiments, he backrest of the bench is fixed and becomes a headboard for the bed. In other embodiments, the backrest is lowered with the bench and/or may fold down over the bench. In various exemplary embodiments, the fixtures are supported by column lifters installed in the utility zone.

In exemplary embodiments, a bed is adapted to be lowered into the space above the lowered bench and table. In preferred embodiments, the bed is articulating between sleeping and sitting positions (i.e., like a hospital bed). In various exemplary embodiments, the bed is sized and positioned to leave a pathway along one side of the room. In preferred embodiments, the dwelling is intended to be wheelchair accessible, and the pathway is sufficient for a wheelchair to pass.

In various exemplary embodiments, storage units are lowered into various parts of the dwelling. For example, closets may be provided in the bathroom or bedroom modules, pantries in the kitchen, shelves for sheets or towels in the bedroom or bathroom, and so forth. The storage unit may be adapted to serve as a closet, dresser, pantry, etc. In various exemplary embodiments, the storage container comprises a door that opens and closes vertically and is counterbalanced with a weight to help maintain the door in an open position and make it easier to open and close. In various exemplary embodiments, the wires used to raise and lower the storage unit also pass through the edges of the door and serve as guides for raising and lowering the door.

In various exemplary embodiments, furniture that is lowered from the storage zone are preferable lowered using a cable and winch system. For safety and aesthetic reasons, it is preferred not to have cables in the residential zone. Therefore, in preferred embodiments, the cables are located at the edge of the residential zone (e.g., in the wall). The cables are affixed to just one side of the furniture piece, such as a bed frame, and guides (e.g., C-shaped channels) are provided along the walls and the furniture is raised and lowered in cantilever fashion. In preferred embodiments, pins attached to the furniture run along the lengths of the vertical channels or guides to keep the furniture from moving horizontally (i.e., swinging). In a more preferred embodiment, the guides comprise two C-shaped channels facing each other to eliminate two degrees of freedom to the moving furniture allowing it to only move up and down.

In various exemplary embodiments, the dwelling unit contains a heat pump to provide heated or cooled air to HVAC ducts located in the utility zone. In preferred embodiments, the heat pump is located at the end of the dwelling opposite the bathroom module with access to outside air (i.e., this end of the dwelling is typically an outside wall). Air is drawn from outside the dwelling, conditioned, and distributed to one or more vents in the dwelling floor. In preferred embodiments, there is at least one air inlet inside the dwelling through which the heat pump also draws air to facilitate air circulation. In various preferred embodiments, the HVAC system includes a humidifier and/or dehumidifier.

In various exemplary embodiments, the HVAC system is designed for continuous operation rather than the typical cycle of on/off used in most systems. The system comprises, among other things, a variable speed fan capable of operating at low speed to maintain a flow of heated or cooled air into the dwelling sufficient to maintain a desired temperature without overheating or overcooling.

All patents, published patent applications, and other publications referred to herein are incorporated herein by reference. The invention has been described with reference to various specific and preferred embodiments and techniques. Nevertheless, it is understood that many variations and modifications may be made while remaining within the spirit and scope of the invention.

What is claimed is:

1. A system for raising and lowering furniture, comprising:
a dwelling unit comprising a residential zone for occupants and a storage zone for furnishings above the residential zone;
at least one lifting device attached to an item of furniture;
at least one runner attached to the item of furniture; and
at least one vertical channel adapted to engage with the at least one runner as the item of furniture is raised or lowered to or from a storage zone above the room;
whereby the furniture is supported by the connection to the lifting device;
whereby the at least one runner travels along the at least one channel as the item of furniture is raised or lowered.

2. The system of claim 1, wherein the at least one lifting device comprises a motor, a spool, and a line.

3. The system of claim 2, wherein the at least one lifting device comprises one motor, two spools, and two lines.

4. The system of claim 2, wherein the at least one lifting device comprises one motor, four spools, and four lines.

5. The system of claim 1, wherein the at least one channel comprises a C-shaped groove.

6. The system of claim 5, wherein the at least one channel comprises two channels facing one another to constrain horizontal motion of the furniture as it is raised or lowered.

7. The system of claim 1, wherein the at least one lifting device is mounted in a mechanical zone above the storage zone.

8. The system of claim 1, wherein the at least one lifting device is attached only on one side of the furniture and the furniture is raised and lowered in cantilevered fashion.

9. A system for adjusting the height of fixtures in a dwelling unit, comprising at least one lifter with a base below the floor line of the dwelling and extending through the floor of the dwelling wherein the lifter is adapted to lower the fixture down to or near floor level.

10. The system of claim 9, wherein the at least one lifter comprises at least one column lifter.

11. A system for rearranging the furniture in a room, comprising:
at least one lifter with a base below the floor line of the room and extending through the floor of the room wherein the lifter is adapted to lower the fixture down to or near floor level;
at least one lifting device attached to an item of furniture;
at least one runner attached to the item of furniture; and
at least one vertical channel adapted to interact with the at least one runner as the item of furniture is raised or lowered to or from a space above the room;
whereby the furnishing is supported by the connection to the lifting device; and
whereby the at least one runner travels along the at least one channel as the item of furniture is raised or lowered.

12. The system of claim 11, wherein the at least one lifting device comprises a motor, a spool, and a line.

13. The system of claim 12, wherein the at least one lifting device comprises one motor, two spools, and two lines.

14. The system of claim 12, wherein the at least one lifting device comprises one motor, four spools, and four lines.

15. The system of claim 11, wherein the at least one channel comprises a C-shaped groove.

16. The system of claim 15, wherein the at least one channel comprises two channels facing one another to constrain horizontal motion of the furniture as it is raised or lowered.

17. The system of claim 11, wherein the at least one lifting device is mounted in a mechanical zone above the storage zone.

18. The system of claim 11, wherein the at least one lifting device is attached only on one side of the furniture and the furniture is raised and lowered in cantilevered fashion.

19. The system of claim 11, wherein the at least one runner comprises a roller.

20. The system of claim 11, wherein the at least one lifter comprises at least one column lifter.
